(19) United States
(12) Patent Application Publication
(10) Pub. No.: US 2020/0086721 A1
(43) Pub. Date: Mar. 19, 2020

(54) Door Assembly for a Transit Vehicle

(71) Applicant: Westinghouse Air Brake Technologies Corporation, Wilmerding, PA (US)

(72) Inventors: Karl J. Kobel, Wildwood, IL (US); Werner Malcherek, Dachau (DE); Timothy R. Schmidt, Wheeling, IL (US)

(21) Appl. No.: 16/228,951

(22) Filed: Dec. 21, 2018

Related U.S. Application Data
(60) Provisional application No. 62/732,359, filed on Sep. 17, 2018.

(51) Int. Cl. B60J 5/04; G09F 9/33; G09F 9/35

(52) U.S. Cl. CPC B60J 5/0497; G09F 21/048; G09F 9/35; G09F 9/33

(57) ABSTRACT

A door assembly for a transit vehicle, the door assembly includes a door frame, and a vehicle door display system including a display configured to display information to a vehicle passenger, and a sensor configured to detect the vehicle passenger when the vehicle passenger is in a predetermined area. The display is configured to change the information when the sensor detects a passenger in the predetermined area.

### CROSS-REFERENCE TO RELATED APPLICATION

This application claims priority to U.S. Provisional Application Ser. No. 62/732,359, filed Sep. 17, 2018, which is hereby incorporated by reference in its entirety.

### BACKGROUND OF THE INVENTION

### Field of the Invention

The present invention is directed to a door assembly for a vehicle and, more particularly, a door assembly for a vehicle having a vehicle door display system.

### Description of Related Art

Transit vehicles, such as buses or passenger railway cars, include one or more doors that are opened and closed to allow the egress and ingress of passengers. Passengers stand near the doors to board the vehicle and also prior to exiting the vehicle.

There are a number of different types of displays used to convey various information or to provide entertainment. The following patents disclose various types of displays and are hereby incorporated by reference in their entirety: EP 3066657A1, Transflective TFT Display; DE202016106621U1, TFT Common Backlight; EP 3291214A3, Dual Use Display; EP 3015915, Transparent Display; and DE 20201610690601, LED Between Glass.

### SUMMARY OF THE INVENTION

In one aspect, a door assembly for a transit vehicle includes a door frame and a vehicle door display system including a display configured to display information to a vehicle passenger and a sensor configured to detect the vehicle passenger when the vehicle passenger is in a predetermined area. The display is configured to change the information when the sensor detects a passenger in the predetermined area.

The door assembly may include a first glass panel and a second glass panel each secured to the door frame, with the display of the vehicle door display system positioned between the first and second glass panels. The display may only occupy a portion of a space between the first and second glass panels. The display may entirely occupy a space between the first and second glass panels.

The door assembly may include a glass panel secured to the door frame, where the display is secured to the glass panel.

The door frame may define an opening, where the display is transparent and received within the opening and secured to the door frame.

The vehicle door display system may further include a communication module configured to receive the information. The communication module may be configured to display real-time information on the display. The information may include one or more of a vehicle state, a door status, local attractions, route information, safety alerts, and advertisements. The door status comprises a closed indication, an authorized indication, an open request indication, an opening indication, and an open indication.

The vehicle door display system may include a user control configured to allow a passenger to select the information on the display. The user control may include a touch screen, an external keypad, a trackpad, or smart phone. The user control may include a camera-based facial expression recognition system or a camera-based gesture recognition system. The user control may include capacitive sensors configured to recognize touch or gestures. The user control is configured to be automatically disabled based on predetermined events.

### BRIEF DESCRIPTION OF THE DRAWINGS

FIG. 1 is a door assembly for a transit vehicle according to one aspect of the present invention.

FIG. 2 is a door assembly for a transit vehicle according to a second aspect of the present invention.

FIG. 3 is a door assembly for a transit vehicle according to a third aspect of the present invention.

FIG. 4 is a door assembly for a transit vehicle according to a fourth aspect of the present invention.

FIG. 5 is a schematic view illustrating how the door assembly described herein may be utilized.

FIG. 6 is a cross-sectional view of a door assembly according to a fifth aspect of the present invention.

FIG. 7 is a cross-sectional view of a door assembly according to a sixth aspect of the present invention.

FIG. 8 is a cross-sectional view of a door assembly according to a seventh aspect of the present invention.

FIG. 9 is a cross-sectional view of a door assembly according to an eighth aspect of the present invention.

FIG. 10 is a schematic view of a vehicle door display system according to one aspect of the present invention.

### DETAILED DESCRIPTION

For purposes of the description hereinafter, spatial orientation terms, as used, shall relate to the referenced embodiment as it is oriented in the accompanying drawing figures or otherwise described in the following detailed description. However, it is to be understood that the embodiments described hereinafter may assume many alternative variations and configurations. It is also to be understood that the specific components, devices, and features illustrated in the accompanying drawing figures and described herein are simply exemplary and should not be considered as limiting.

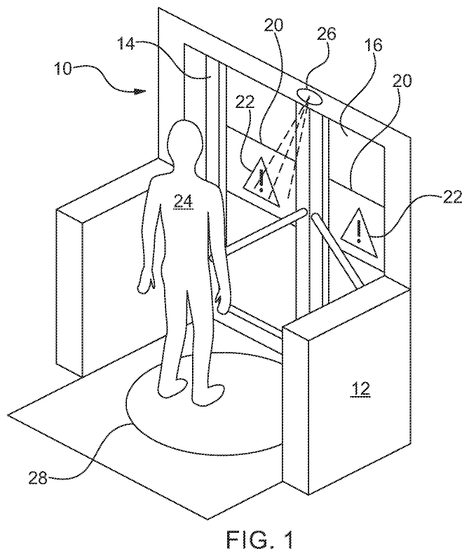

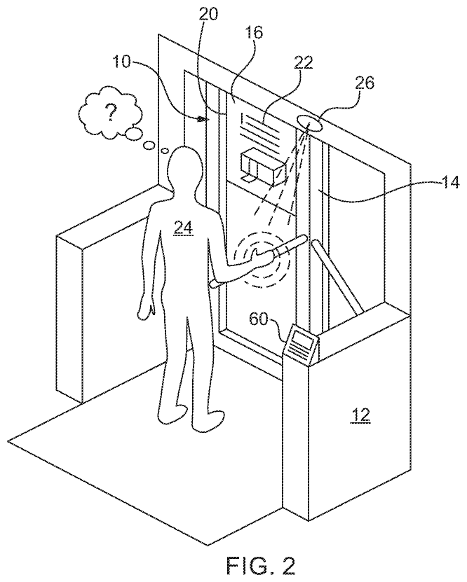

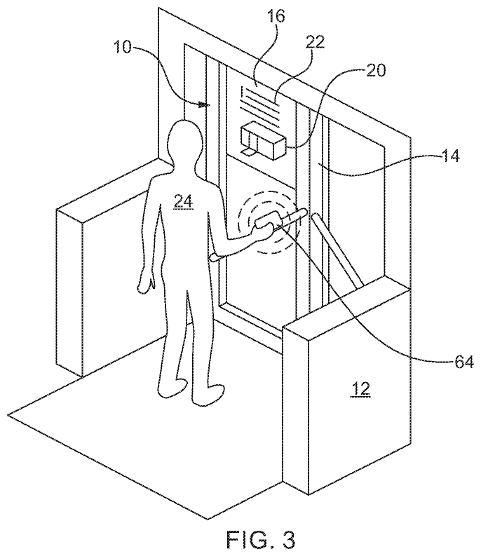

Referring to FIGS. 1-10, a door assembly 10 for a transit vehicle 12 according to one aspect of the present disclosure is shown. The door assembly 10 includes a door frame 14 and a vehicle door display system 16. The door frame 14 defines an opening 18 configured to receive a glass panel. The door assembly 10 may be opened and closed using any suitable actuation mechanism (not shown), which may be automatic and/or manually-controlled by an operator. The transit vehicle 12 may be a bus, railway passenger vehicle, or any other suitable vehicle. The vehicle door display system 16 includes a display 20 configured to display information 22 to a vehicle passenger 24 and a sensor 26 configured to detect the vehicle passenger 24 when the vehicle passenger 24 is in a predetermined area 28. The display 20 is configured to change the information 22 when the sensor 26 detects the passenger in the predetermined area 28. The display 20 may be manufactured with at least one of the following technologies: thin-film transistor (TFT) liquid-crystal, organic light-emitting diode (OLED), or electronic ink (eINK), although other suitable display technologies may also be utilized. The sensor 26 may include one or more of the following: a passive infrared (PIR) sensor, a microwave sensor, an ultrasonic sensor, a vibration sensor, a pressure/contact sensor, a camera-based sensor, or any other suitable sensor configured to detect the position of one or more vehicle passengers. The change in the information 22 displayed on the display 20 when the sensor 26 detects the passenger 24 in the predetermined area 28 may be to display a door opening indicator to notify the passenger of the opening door, to activate advertisements, to activate a safety alert instructing the passengers to exit the specified area due to door opening or restrictions while the vehicle is moving, etc.

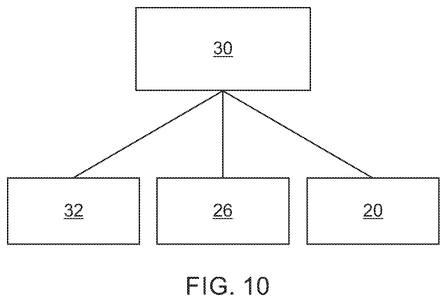

As shown in FIG. 10, the vehicle door display system 16 also includes at least one processor 30, or any other like computing device, for controlling the vehicle door display system 16, and a communications module 32 configured to receive information from a user, a network, or other suitable source. The communications module 32 is configured to display real-time information on the display 20, although the vehicle door display system 16 may also include preloaded messages or content stored on a storage or memory device. The communications module 32 may include one or more of an input port, such as a USB port, a cellular mobile communication device, a wireless local area networking device, and any other suitable communications device for receiving and transmitting information.

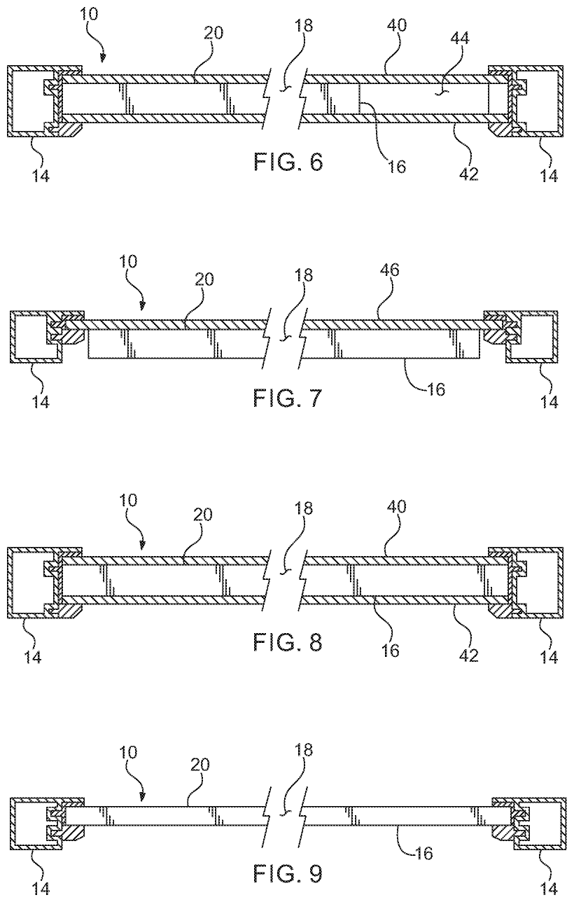

Referring to FIGS. 6 and 8, in one aspect of the present disclosure, the door assembly 10 includes a first glass panel 40 and a second glass panel 42 each secured to the door frame 14. The display 20 of the vehicle door display system 16 is positioned between the first and second glass panels 40, 42. As shown in FIG. 6, the display 20 may only occupy a portion of a space 44 between the first and second glass panels 40, 42. As shown in FIG. 8, the display 20 may entirely occupy the space 44 between the first and second glass panels 40, 42.

Referring to FIG. 7, in one aspect of the present disclosure, the door assembly 10 includes a single glass panel 46 secured to the door frame 14 with the display 20 secured to the glass panel 46.

Referring to FIG. 9, in one aspect of the present disclosure, the display 20 of the door assembly 10 is transparent and received within the opening 18 of the door frame 14 and secured to the door frame 14. The display 20 being transparent or partially transparent is configured to allow the passenger 24 to view the information on the display 20 while still being able to at least partially view objects on the opposite side of the display 20. The display 20 may be configured to impose a limit on the visibility or transparency, which is pre-programmed or selected by the passenger 24 or operator.

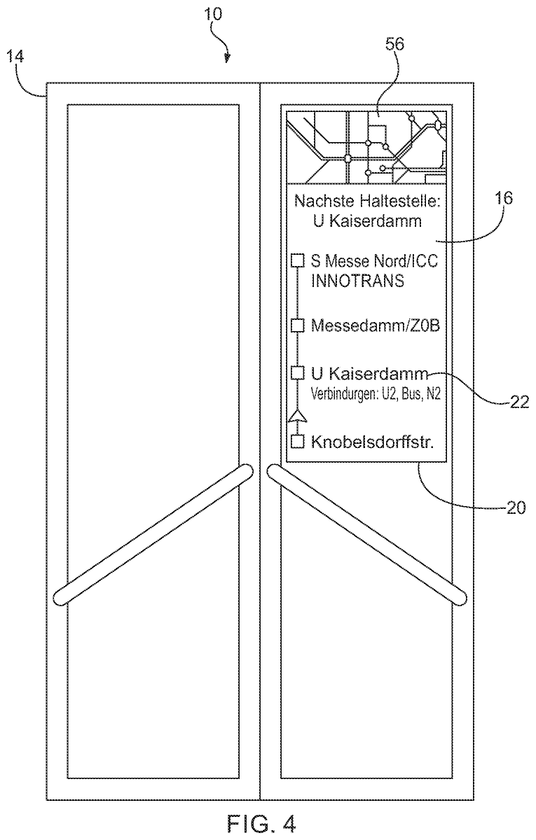

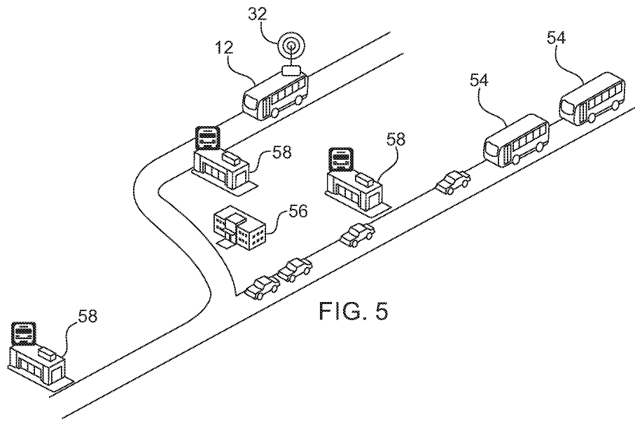

The information 22 displayed on the display 20 of the vehicle door display system 16 may be one or more of a vehicle state, a door status, local attractions, route information, safety alerts, and advertisements, although other suitable information may also be displayed. The door status may include a closed indication, an authorized indication, an open request indication, an opening indication, and an open indication, although other suitable door status indicators may be utilized. Referring to FIG. 4, the route information may include a system map 52 with the current vehicle location or other suitable information. Referring to FIG. 5, the information displayed on the display 20 may be based on the location of the transit vehicle 12, the position of other transit vehicles 54 for possible transfers, the location of the transit vehicle relative to a transit stop 56 or bus depot 58, etc.

Referring to FIGS. 1-3, the vehicle door display system 16 may include a user control 60 configured to allow the passenger 24 to select the information 22 on the display 20. The user control 60 may include one or more of the following: a touch screen, an external keypad, a trackpad, a smart phone 64, or any other suitable device or arrangement. The user control 60 may be a camera-based facial expression recognition system or camera-based gesture recognition system, which may be integral with the sensor 26 or formed separately from the sensor 26. The user control 60 may include capacitive sensors configured to recognize touch or gestures. The user control 60 may be configured to be automatically disabled based on predetermined events. For example, the user control 60 may be disabled as needed for safety purposes with alerts regarding the disabled user control or restricted actions being provided on the display. The predetermined events may be an upcoming transit stop, a vehicle emergency, police emergency, etc. The user control 60 and display 20 may be configured to allow external content such as advertising or entertainment to be displayed. The content may be responsive to the sensor inputs and user controls previously detailed such as to display locally relevant content, to browse advertisements, to control entertainment channels, to provide interactive entertainment and ads, or other purposes.

While embodiments of a door assembly were provided in the foregoing description, those skilled in the art may make modifications and alterations to these embodiments without departing from the scope and spirit of the invention. Accordingly, the foregoing description is intended to be illustrative rather than restrictive. The invention described hereinabove is defined by the appended claims and all changes to the invention that fall within the meaning and the range of equivalency of the claims are to be embraced within their scope.

The invention claimed is:

1. A door assembly for a transit vehicle, the door assembly comprising:
a door frame; and
a vehicle door display system comprising a display configured to display information to a vehicle passenger, and a sensor configured to detect the vehicle passenger when the vehicle passenger is in a predetermined area, wherein the display is configured to change the information when the sensor detects a passenger in the predetermined area.

2. The door assembly of claim 1, further comprising a first glass panel and a second glass panel each secured to the door frame, the display of the vehicle door display system positioned between the first and second glass panels.

3. The door assembly of claim 1, further comprising a glass panel secured to the door frame, wherein the display is secured to the glass panel.

4. The door assembly of claim 2, wherein the display only occupies a portion of a space between the first, and second glass panels.

5. The door assembly of claim 2, wherein the display entirely occupies a space between the first and second glass panels.

6. The door assembly of claim 1, wherein the door frame defines an opening, the display is transparent and received within the opening and secured to the door frame.

7. The door assembly of claim 1, wherein the vehicle door display system further comprises a communication module configured to receive the information.

8. The door assembly of claim 7, wherein the communication module is configured to display real-time information on the display.

9. The door assembly of claim 1, wherein the information comprises one or more of a vehicle state, a door status, local attractions, route information, safety alerts, and advertisements.

10. The door assembly of claim 9, wherein the door status comprises a closed indication, an authorized indication, an open request indication, an opening indication, and an open indication.

11. The door assembly of claim 1, wherein the vehicle door display system further comprises a user control configured to allow a passenger to select the information on the display.

12. The door assembly of claim 11, wherein the user control comprises a touch screen, an external keypad, a trackpad, or smart phone.

13. The door assembly of claim 11, wherein the user control comprises a camera-based facial expression recognition system or camera-based gesture recognition system.

14. The door assembly of claim 11, wherein the user control comprises capacitive sensors configured to recognize touch or gestures.

15. The door assembly of claim 11, wherein the user control is configured to be automatically disabled based on predetermined events.
